(19) United States
(12) Patent Application Publication
(10) Pub. No.: US 2006/0258018 A1
(43) Pub. Date: Nov. 16, 2006

(54) Method and apparatus for determining the area or confluency of a sample

(76) Inventors: Claire L. Curl, Burwood (AU); Lea M. D. Delbridge, Kensington (AU); Peter J. Harris, Williamstown (AU); Catherine J. Bellair, Parkville (AU); Brendan E. Allman, East Brunswick (AU)

Correspondence Address: FISH & RICHARDSON P.C., P.O. BOX 1022, MINNEAPOLIS, MN, 55440-1022, US

(21) Appl. No.: 10/595,198

(22) PCT Filed: Sep. 16, 2004
(86) PCT No.: PCT/AU04/01261

§ 371 Date: Mar. 30, 2006

(30) Foreign Application Priority Data
Sep. 23, 2003 (AU) 04001261

(51) Int. Cl. G01N 1/10

(52) U.S. Cl. 436/180

(57) ABSTRACT

The area or confluency of a sample is determined by obtaining quantitative phase data relating to the sample and background surrounding the sample. The boundary of the sample is determined from the quantitative phase data by forming a histogram of phase data measurements and taking the derivative of the histogram to thereby determine the point of maximum slope. The line of best fit on the derivative is used to obtain a data value applicable to the boundary so that data values either above or below the determined data value are deemed within the sample.

### FIELD OF THE INVENTION

This invention relates to a method and apparatus for determining the area or confluency of a sample. The invention has particular application to generally transparent samples such as cells to enable the area or confluency of cells to be determined so that effects of growth and confluency can be measured. However, it should be understood that the invention also has application to other sample types.

### BACKGROUND ART

Considerable difficulty can be experienced in measuring the area or confluency of some samples and, in particular, transparent samples. This is primarily due to the difficulty in determining where the boundary of the sample actually is so that the area or confluency of the sample can be measured. Viable cells are transluscent objects that are difficult to visualise because there is usually little difference in contrast between cytoplasm and background. Cellular structures can be imaged and identified after staining or labelling, but this effects the viability of the specimen. Visualising living cells in culture is particularly difficult due to their transparent nature, and also because there are inherent problems associated with imaging through plastic culture ware. It is important to be able to image living cells in culture, not just for lineage maintenance, but also for evaluating the effects of growth intervention in vitro.

Transparent viable unstained specimens, such as cells, can be visualised using optical phase microscopy which enhances discrimination of the cells from their background. Optical phase microscopy was invented in the 1930's by Fitz Zernike, and uses a phase plate to change the speed of light passing directly through a specimen so that it is half wavelength different from light deviated by the specimen. This method results in destructive interference and allows the details of the image to appear dark against a light background. This visualisation of the phase properties of a cell provides important information about refractive index and thickness in phase rich, amplitude poor transparent objects, which would otherwise yield little information when examined using bright field microscopy. Various implementations of phase microscopy have been utilised in order to visualise unstained, transparent specimens, including Dark Field, Differential Interference Contrast, and Hoffman Modulation Contrast. Although each of these methods allows enhanced visualisation of transparent specimens, they all have inherent problems, including cell edge distortion and the generation of distinct halos at the edges of the cells, making visual analysis difficult. More importantly, the information provided by these techniques is useful for qualitative analysis only.

### SUMMARY OF THE INVENTION

The object of the invention is to provide a method and apparatus for enabling the area or confluency of a sample to be determined, which does not destroy the sample, and which also avoids the above-mentioned problems of prior art optical techniques.

The invention provides a method of determining the area or confluency of a sample, comprising:
providing quantitative phase data relating to the sample and background surrounding the sample;
determining from the quantitative phase data the boundary of the sample; and
determining the area within the boundary in order to determine either the area of the sample or the confluency of the sample. Since quantitative phase data is used to obtain the area, the sample is not destroyed, as may be the case if staining is involved. Thus, growth patterns of the sample can be measured over a predetermined time period if desired by making subsequent measurements of the sample over the predetermined time period. Furthermore, the quantitative phase data avoids difficulties associated with cell edge distortion and generation of halos, and makes it much easier to identify the actual boundary of the sample, thereby providing the determination of the area or confluency of the sample.

Preferably the quantitative phase data is obtained by detecting light from the sample by a detector so as to produce differently focused images of the sample, and determining from the different images the quantitative phase data by an algorithm which solves the transport of intensity equation so as to produce a phase map of the sample in which the phase data is contained.

Most preferably the equation is solved in accordance with the method described in International Patent Application No. PCT/AU99/00949 in the name of Melbourne University, and International Application No. PCT/AU02/01398 in the name Iatia Imaging Pty Ltd. The contents of these two International applications are incorporated into this specification by this reference.

Preferably the step of determining the boundary of the sample comprises forming a histogram of quantitative phase data measurements of the sample and background, taking the derivative of the histogram to thereby determine the point of maximum slope of the histogram in the vicinity of the boundary of the sample, and determining a line of best fit on the derivative to obtain a data value applicable to the boundary so that data values either above or below the determined data value are deemed within the sample.

Preferably the step of determining the area or confluency comprises determining the area of confluency from the number of data samples which are within the boundary.

In the preferred embodiment of the invention, each data sample is applicable to a pixel of a detector and the area of each pixel is known, so that from the known area of the pixels and the number of pixels which register a data value above or below the predetermined data value, the area or confluency of the sample is determined.

The invention may also be said to reside in a method of determining the area or confluency of a sample comprising:
detecting light emanating from the sample by a detector to form at least two images of the sample which are differently focused to provide two sets of raw data;
from the two sets of raw data, determining a quantitative phase map of the sample and its background;
determining a boundary of the sample from individual phase data values applicable to pixels of the detector which are either above or below a determined pixel value; and
determining the area or confluency by multiplying the pixel area by the number of pixels which are either above or below the determined pixel value to thereby determine the area or confluency of the sample.

Preferably the pixel values are grey scale values and grey scale values above a determined grey scale value are deemed to be within the sample and are multiplied by the pixel area to determine the area or confluency of the sample.

Preferably the determined pixel value is determined by identifying the greatest rate of change of grey scale pixel values, thereby identifying the boundary of the sample.

Preferably the greatest rate of change is determined by forming a histogram of grey scale values for all of the pixels which detect the sample and its background, determining the derivative of the histogram to provide a graphical measure of the greatest rate of change of grey scale values at various pixels, and determining the line of best fit of the curve to determine the grey scale value which defines the boundary of the sample so that all grey scale values which are greater than the determined grey scale value are deemed to be within the sample.

Preferably the raw data comprises at least one in focus image of the sample and at least one out of focus image of the sample.

Most preferably the raw data comprises the in focus image of the sample and one positively defocused image and one negatively defocused image of the sample.

The invention provides an apparatus for determining the area or confluency of a sample, comprising:
a processor for:
receiving quantitative phase data relating to the sample and background surrounding the sample;
determining from the quantitative phase data the boundary of the sample; and
determining the area within the boundary in order to determine either the area of the sample or the confluency of the sample.

Preferably the apparatus further comprises a detector for producing differently focused images of the sample, and the processor is for determining from the different images the quantitative phase data by an algorithm which solves the transport of intensity equation so as to produce a phase map of the sample in which the phase data is contained.

Preferably the processor determines the boundary of the sample by forming a histogram of quantitative phase data measurements of the sample and background, taking the derivative of the histogram to thereby determine the point of maximum slope of the histogram in the vicinity of the boundary of the sample, and determining a line of best fit on the derivative to obtain a data value applicable to the boundary so that data values either above or below the determined data value are deemed within the sample.

Preferably the processor determines the area or confluency comprises determining the area of confluency from the number of data samples which are within the boundary.

In the preferred embodiment of the invention, each data sample is applicable to a pixel of a detector and the area of each pixel is known, so that the processor, from the known area of the pixels and the number of pixels which register a data value above or below the predetermined data value, determines the area or confluency of the sample.

The invention may also be said to reside in an apparatus for determining the area or confluency of a sample comprising:

a detector for detecting light emanating from the sample to form at least two images of the sample which are differently focused to provide two sets of raw data;

a processor for determining from the two sets of raw data, a quantitative phase map of the sample and its background;

the processor also determining a boundary of the sample from individual phase data values applicable to pixels of the detector which are either above or below a determined pixel value; and

the processor also determining the area or confluency by multiplying the pixel area by the number of pixels which are either above or below the determined pixel value to thereby determine the area or confluency of the sample.

Preferably the pixel values are grey scale values and grey scale values above a determined grey scale value are deemed to be within the sample and are multiplied by the pixel area to determine the area or confluency of the sample.

Preferably the determined pixel value is determined by identifying the greatest rate of change of grey scale pixel values, thereby identifying the boundary of the sample.

Preferably the greatest rate of change is determined by the processor forming a histogram of grey scale values for all of the pixels which detect the sample and its background, determining the derivative of the histogram to provide a graphical measure of the greatest rate of change of grey scale values at various pixels, and determining the line of best fit of the curve to determine the grey scale value which defines the boundary of the sample so that all grey scale values which are greater than the determined grey scale value are deemed to be within the sample.

Preferably the raw data comprises at least two defocused images equally spaced either side of the focus.

Most preferably the raw data comprises the in focus image of the sample and one positively defocused image and one negatively defocused image of the sample.

The invention provides a computer program for determining the area or confluency of a sample from providing quantitative phase data relating to the sample and background surrounding the sample, comprising:
code for determining from the quantitative phase data the boundary of the sample; and
code for determining the area within the boundary in order to determine either the area of the sample or the confluency of the sample.

Preferably the quantitative phase data is obtained by detecting light from the sample by a detector so as to produce differently focused images of the sample, and the program includes code for determining from the different images the quantitative phase data by an algorithm which solves the transport of intensity equation so as to produce a phase map of the sample in which the phase data is contained.

Preferably the code for determining the boundary of the sample comprises code for forming a histogram of quantitative phase data measurements of the sample and background, code for taking the derivative of the histogram to thereby determine the point of maximum slope of the histogram in the vicinity of the boundary of the sample, and code for determining a line of best fit on the derivative to obtain a data value applicable to the boundary so that data values either above or below the determined data value are deemed within the sample.

Preferably the code for determining the area or confluency comprises code for determining the area of confluency from the number of data samples which are within the boundary.

In the preferred embodiment of the invention, each data sample is applicable to a pixel of a detector and the area of each pixel is known, so that from the known area of the pixels and the number of pixels which register a data value above or below the predetermined data value, the area or confluency of the sample is determined.

The invention may also be said to reside in a computer 10 program for determining the area or confluency of a sample by detecting light emanating from the sample by a detector to form at least two images of the sample which are differently focused to provide two sets of raw data, comprising:
code for determining from the two sets of raw data, a quantitative phase map of the sample and its background;
code for determining a boundary of the sample from individual phase data values applicable to pixels of the detector which are either above or below a determined pixel value; and
code for determining the area or confluency by multiplying the pixel area by the number of pixels which are either above or below the determined pixel value to thereby determine the area or confluency of the sample.

Preferably the pixel values are grey scale values and grey scale values above a determined grey scale value are deemed to be within the sample and are multiplied by the pixel area to determine the area or confluency of the sample.

Preferably the determined pixel value is determined by code for identifying the greatest rate of change of grey scale pixel values, thereby identifying the boundary of the sample.

Preferably the greatest rate of change is determined by code for forming a histogram of grey scale values for all of the pixels which detect the sample and its background, code for determining the derivative of the histogram to provide a graphical measure of the greatest rate of change of grey scale values at various pixels, and code for determining the line of best fit of the curve to determine the grey scale value which defines the boundary of the sample so that all grey scale values which are greater than the determined grey scale value are deemed to be within the sample.

Preferably the raw data comprises at least one in focus image of the sample and at least one out of focus image of the sample.

Most preferably the raw data comprises the in focus image of the sample and one positively defocused image and one negatively defocused image of the sample.

### BRIEF DESCRIPTION OF THE DRAWINGS

A preferred embodiment of the invention will be described, by way of example, with reference to the accompanying drawings in which:

FIG. 1 is a view of an apparatus embodying the invention;

FIG. 2 is a view of an image of a sample as formed on a detector used in the embodiment of FIG. 1;

FIG. 3 is a histogram of sample values used to identify a boundary of the sample in the image of FIG. 2;

FIG. 4 is a graph showing the derivative of the histogram curve of FIG. 3.

### DETAILED DESCRIPTION OF ONE EMBODIMENT OF THE INVENTION

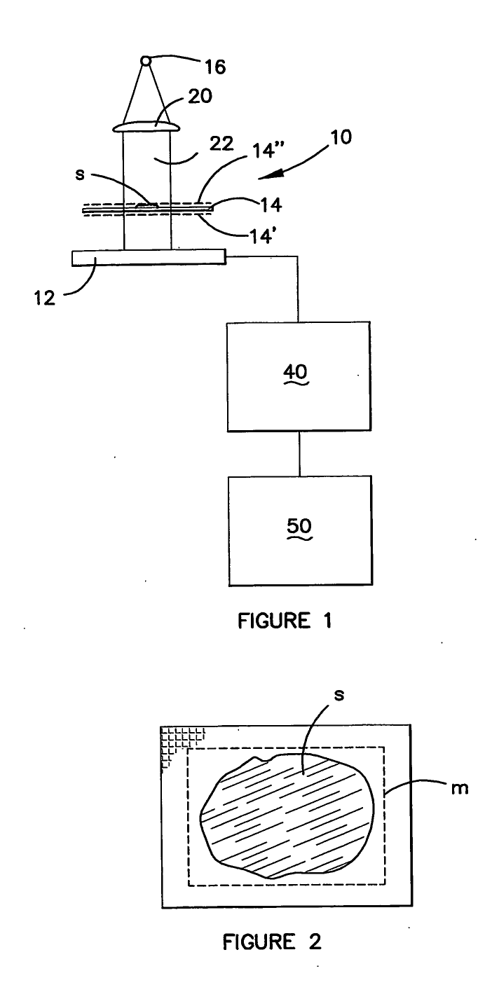

With reference to FIG. 1, an apparatus 10 is shown for determining the area or confluency of a sample. The apparatus 10 comprises a detector 12 such as a charge coupled device type camera or the like. The camera 12, as is well known, is formed from a number of pixels generally in a rectangular array.

A sample stage 14 is provided for holding a sample such as a cell in a transparent dish or on a slide, etc. A light source 16 is provided for providing light. The reference to light used in the specification should be understood to mean visible as well as non-visible parts of the electromagnetic spectrum, and also particle or acoustic radiation.

The light from the sample 16 passes through conditioning optics schematically shown at 20 so as to form a beam of light 22 which passes through the sample S and which is detected by the detector 12.

In order to form a quantitative phase map of the sample S and its surrounding background, three images of the sample are produced at different focuses. The first image is an in focus image at the position of the stage 14 shown in FIG. 1. The second image is a positively defocused image at the position 14′, and the third image is a negatively defocused image at the position 14″. The raw data obtained by these three images is used in an algorithm to solve the transport of intensity equation so that quantitative phase data relating to the sample and the background surrounding the sample is obtained. The algorithm used to form the quantitative phase map is disclosed in the aforementioned International applications, and therefore will not be repeated in this specification. It should be understood that whilst this method of forming the quantitative phase map is preferred, other techniques for providing the quantitative phase map of the sample may also be used.

The quantitative phase map is produced in processor 40, which is connected to the detector 12, and a phase image of the sample S may be viewed on a monitor 50 connected to the processor 40.

FIG. 2 is a view of the image which may be obtained which shows the sample S and its surrounding background, which is most conveniently white. The algorithm which solves the transport of intensity equation therefore is able to provide a quantitative phase measure at each pixel of the detector 12, applicable to the sample S and its surrounding background. If desired, the background of the sample S may be masked by a mask M as shown in FIG. 2, so that spurious events such as dust or the like which may be in the background is reduced to a minimum. Each of the pixels of the detector 12 within the mask M is therefore provided with a grey level value of from between 0 and 255, which is indicative of the quantitative phase measurement at that pixel of the sample S and its surrounding background within the mask M.

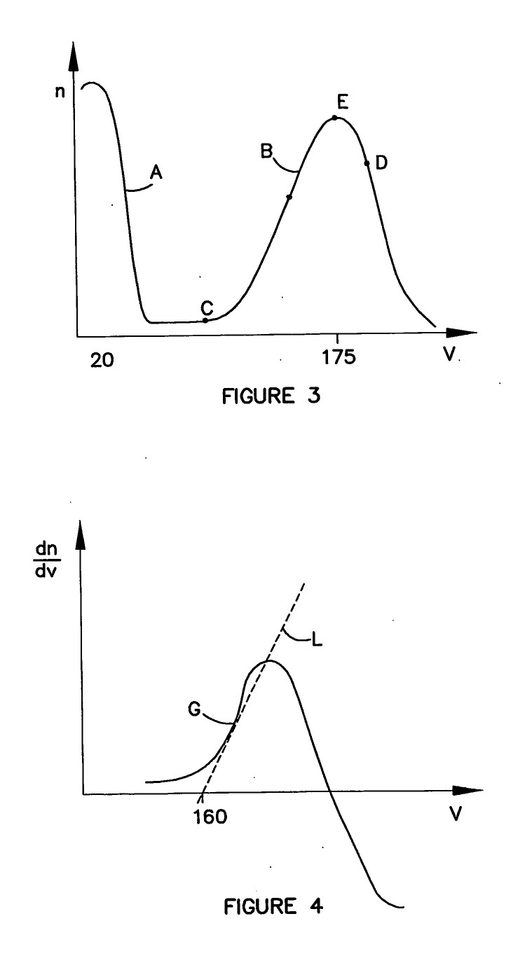

Once the quantitative phase data for each pixel in the detector 12 has been determined, a histogram as shown in FIG. 3 of the grey scale values for the pixels can be created. Typically, the histogram will be similar to that shown in FIG. 3, in which the surrounding background has a very low grey scale value V applicable to “black light” or zero phase retardation of the light as it passes by the sample S. It should be understood that usually this grey scale image is seen as a white on black image so that the background area surrounding the sample S is typically black and the image of the sample appears white. However, if the nature of the system is such that the background area is thicker and has more phase retardation than the sample, then the opposite will be the case and, furtherstill, if desired, the usual image could be inverted so that the background appears white and the sample appears as a darker or black contrast. The grey scale value within the sample S will increase because of phase retardation as the light passes through the sample S, thereby tending to provide a lighter colour and therefore a higher grey level value V. Typically, the mean value of the sample S may be, for example, a grey level of 175 as shown in FIG. 3.

The boundary of the sample S will be indicative of the location where there is the greatest change between adjacent pixel values. The reason for this is that outside the boundary, the background will provide no retardation, and therefore a very low grey level value of, for example, 20. At the boundary, and within the sample S, the pixel value will be much higher. Thus, by determining the point on the histogram which is in the area of the sample boundary, and which shows the greatest rate of change, an indication of the grey level value at the boundary of the sample S can be obtained. In order to determine the greatest rate of change, the derivative of the histogram function in the vicinity of the boundary is determined. This is also performed by the processor 40.

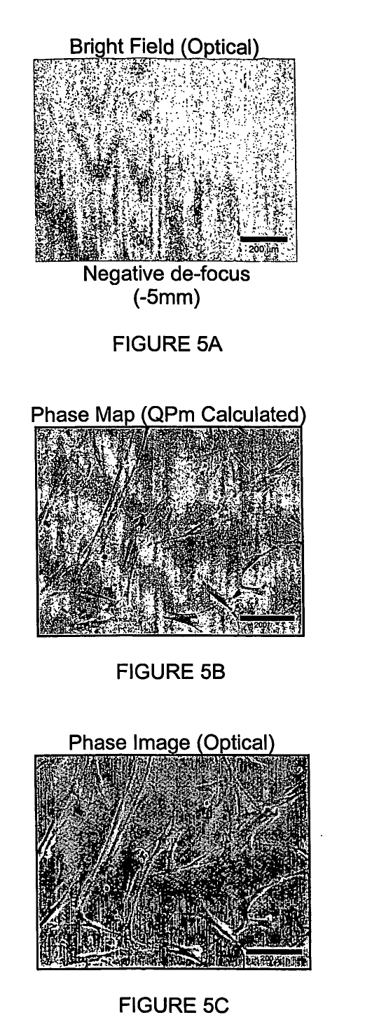

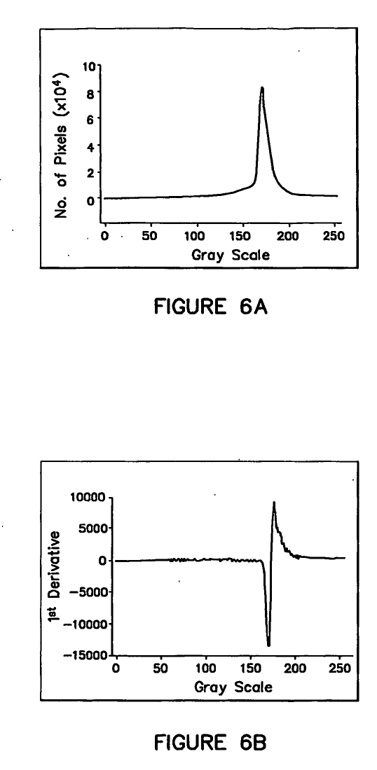

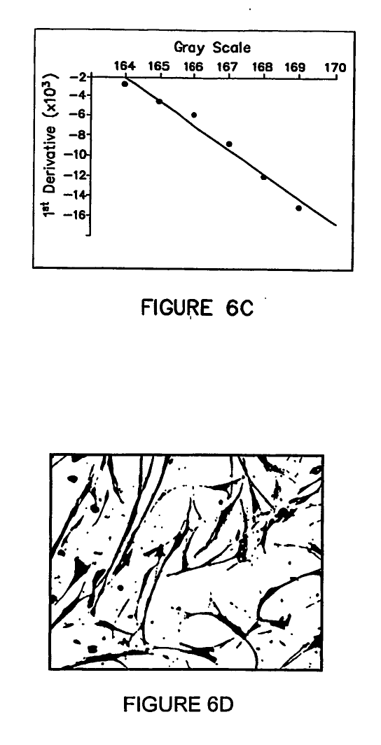

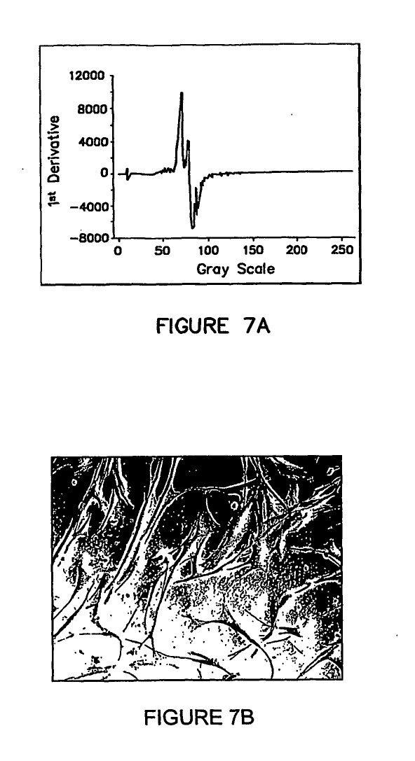

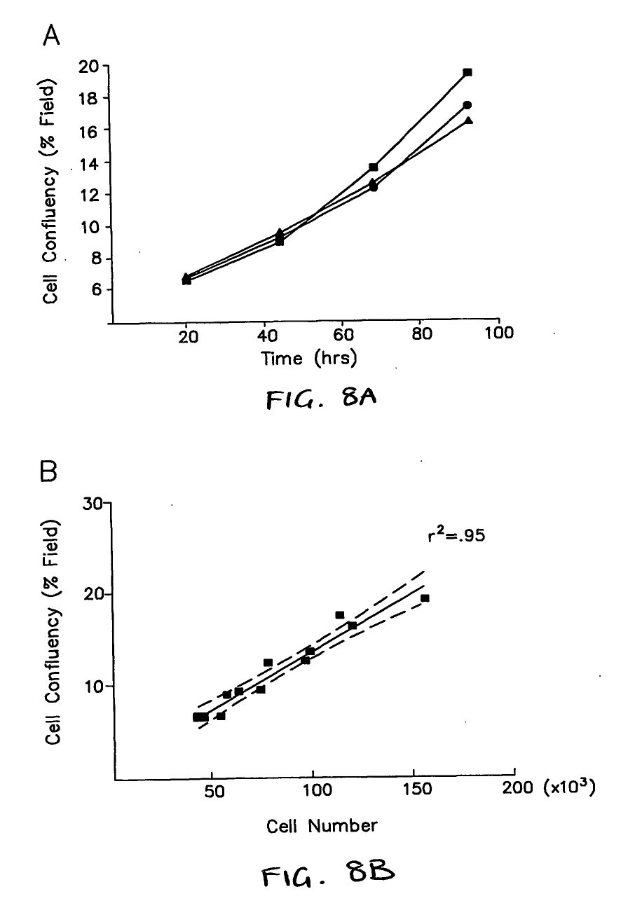

A user can identify the likely location of the boundary by viewing the histogram in FIG. 3. The part of the curve marked A in FIG. 3 will be clearly attributable to the large number of pixels which show background and will generally have a very low grey scale value because of no phase retardation by the sample S. The part of the curve marked B in FIG. 3 will be recognised to be in the boundary region, and the derivative function can typically be taken of the part of the curve between the points, for example, C and D in FIG. 3. The turning point E of the graph will be the part of the derivative which crosses the X axis in FIG. 4 and the part of the curve G in FIG. 4 will be the line which identifies the grey level value V in FIG. 4 attributable to the boundary of the sample S.

Thus, by forming a line L in FIG. 4 of best fit to the part of the curve G, the grey scale value of the pixels which identify the boundary can be determined. In the example of FIG. 4, the grey scale value is 160.

The area or confluency of the sample S is therefore determined by determining the number of pixels which provide a grey scale value of 160 or greater, and multiplying the number of such pixels by the area of each pixel. This will therefore provide the area of the sample S or the confluency of the sample if the sample is a number of cells which are joined together.

Examples of the invention are given below.

Airway smooth muscle cells were obtained by collagenase and elastase digestion from bronchi of lung transplant resection patients. Cultures were maintained in phenol red-free DMEM with 10% FCS, supplemented with 2 mM L-glutamine, 100 U/ml penicillin-G, 100 μg/ml streptomycin and 2 μg/ml amphotericin B. Cells were passaged weekly at a 1:4 split ratio by exposure to 0.5% trypsin containing 1 mmol/L EDTA. For experiments measuring confluency, cells were seeded onto plastic culture dishes at 2.5×10⁴-4×10⁴ cells/well in media as above. A period of 24 hours was allowed for adherence of cells to the culture dish and measurements were then obtained daily with a media change after 3 days.

### EXAMPLE 1

Bright field images were captured using a black and white 1300×1030 pixel Coolsnap FX CCD camera (Roper Scientific) mounted on a Zeiss Axiovert 100M inverted microscope utilising a Zeiss Plan-Neofluar (×10, 0.30 NA) objective. To ensure optimal specimen illumination, Köhler illumination conditions were established for each optical arrangement (condenser and objective alignment and condenser stop at 70% field width). In order to calculate the phase map, one in-focus, and equidistant positive and negative de-focus images were acquired, using a defocus distance of zz μm in this instance. This was achieved using a piezoelectric positioning device (PiFoc, Physik Instrumente, Karlsruhe, Germany) for objective translation. Bright field images were subsequently processed to generate phase maps using QPm software (v2.0 IATIA Ltd, Australia). The phase map generation, based on the set of three bright field images captured, involved software-automated calculation of the rate of change of light intensity between the three images[6]. In addition to the set of images obtained for phase map calculation, for each specimen an image using conventional optical phase techniques was also acquired (Plan-Neofluar, ×10, NA 0.30) in order that a comparison of calculated and optical phase imaging techniques could be performed. An example and comparative view of the three different image types (bright field, phase map and optical phase) are shown in FIG. 5. The lack of structural detail observable in the bright field image is notable when compared to the two phase images (FIG. 5A). The distinct cell boundary definition achieved using the QPm software calculated phase map (FIG. 5B) when compared with an optically derived phase image (FIG. 5C) is also apparent.

Phase map images were analysed to evaluate confluency and to measure the growth of the cultured muscle cells over the period of 92 hours. Reproducible location of a reference point within the culture dish was achieved using a mark on the base of the culture plate and by reference to the gradation scale on the microscope stage. This enabled measurements of the same area of cells (those in the field surrounding the centred reference point) over the extended time period at 24 hour intervals.

Culture plates were set up so that parallel measurements of confluency and determination of cell number could be performed at each time interval. Following phase image capture, cells were lifted from the culture substrate by exposure to trypsin (0.5% v/v containing 1 mmol EDTA) and counted using standard haemocytometry. To ensure uniform growth rates across the 6 well plates, all wells were seeded at the same density, from the same cell passage type, and were exposed to identical incubation conditions. One well of the six well plate was repeatedly imaged for daily confluency measurement with the remaining five wells harvested one per day for cell number determination. The relationship between cell growth measurements obtained by confluency measurement of phase maps and by haemocytometric cell counting methods was estimated.

Inspection of the images presented in FIG. 5 illustrates the difficulties encountered in visualising cultured cell monolayers under bright field conditions. The cellular outlines and processes are barely discernible in FIG. 5A, despite the optimised Koehler illumination conditions. In FIG. 5B, as is typically observed, the calculated phase map exhibits a much enhanced dynamic contrast range. The optical phase image of the same field presented in FIG. 5C offers somewhat improved contrast relative to the bright field image. This is particularly accentuated (and somewhat distorted) at the cell boundaries, but the optical phase view provides less useful contrast between the internal cellular and non-cellular image features.

Phase maps (ie FIG. 5B) were analysed (using the QPm software image analysis tools) to construct pixel intensity histograms (FIG. 6A) to identify phase shift characteristics associated with cellular structures. Scrutiny of numerous phase map histograms indicated that the initial portion of the steepest gradient of the histogram could be used to reproducibly demarcate cellular material from extracellular material. A linear function was fit to the ascending portion of the derivative of the intensity histogram (FIG. 6B) and extrapolated to the x-axis to obtain the threshold grey level at which segmentation of cellular from non-cellular material could be achieved using the phase map (FIG. 6C). This novel calculation provides an entirely non-subjective technique of image segmentation for cell delineation. The extrapolated threshold value was then utilised to construct a binary image (Image-Pro Plus software v3.0 Media Cybernetics, USA) representing demarcation of cellular material from non-cellular material in the phase image (see FIG. 6D). The binary map generated by these segmentation manipulations is simply used to sum the quantity of ‘black’ delimited cellular material on the culture plate as a measure the confluency of the culture, expressed as a percentage of the total field area examined. (% section area). For the culture used as a ‘case’ image analysis presented in FIGS. 5 and 6, this value was 5.68%, a value typical for cultures at about 20 hr post seeding under these conditions.

An 8 bit image (grey scale representing values ranging from 0-255) as found to be optimal for the segmentation procedure summarised above. The analysis was also undertaken using a 12 bit image to increase the contrast range available, and potentially to improve the precision of determination of the threshold point. However, an increase in noise in the 12 bit image histograms was generally observed to offset any improvement in the determination of the threshold grey-level.

This analysis procedure allows for an accurate and non-biased calculation of the threshold point with which to distinguish cells from background. Of crucial importance in achieving a successful thresholding outcome in this process is the quality of data available in the phase map where haloing and cell edge distortion is suppressed allowing for accurate cell delineation. When the same analysis procedure was attempted with an image captured using conventional optical phase techniques, a reliable outcome could not be achieved (FIG. 7). The reduced difference in contrast between cellular and non-cellular material in the optical phase image renders the curve-fitting procedure unstable, while the effect of uneven illumination intensity in the optical image produces regional variation in the thresholding process. Inspection of the derivatives generated from the optical phase image intensity histograms revealed that these plots are somewhat more complex than those extracted from the phase maps and exhibit multiple peaks (FIG. 7A). Thus the process of intercept extrapolation cannot be easily applied to these plots and it is not possible to employ a non-subjective thresholding method. The difficulties associated with segmentation of optical phase images are exemplified in FIG. 7B, where it is apparent that the binary image produced by thresholding incorporates extracellular regions at the top left of the image (FIG. 3D) and fails to delineate boundaries at other locations in the lower portion of the image. The combined effect of this lack of field uniformity and cell delineation difficult, markedly over-estimates the confluency status of this culture specimen by more than 2-fold when compared to the phase map determination using similar thresholding methods.

Phase-map thresholding and segmentation techniques were applied to measure the progressive increase in confluency of HASM cell cultures from several different patient cell lines. Following re-passaging and seeding at standardized density, culture growth was tracked by repeated imaging over a 92 hour time period. As shown in FIG. 8A, an approximately linear growth response was observed over this period, with the degree of confluency increasing from about 8% at 24 hours to around 17% after 92 hours.

FIG. 8B illustrates the correlation between the quantitative phase calculated culture confluency and cell number determined by haemocytometry for the same culture wells throughout this growth period for the three lines tracked in FIG. 5A. A high degree of correlation (r²=0.95) is observed between these two growth measures. These findings indicate that in circumstances where proliferative growth is conventionally (and destructively) assessed by cell harvest and counting, the use of in situ QPM imaging methods provides a reliable and non-destructive surrogate.

1. A method of determining the area or confluency of a sample, comprising:
providing quantitative phase data relating to the sample and background surrounding the sample;
determining from the quantitative phase data the boundary of the sample; and
determining the area within the boundary in order to determine either the area of the sample or the confluency of the sample.

2. The method of claim 1 wherein the quantitative phase data is obtained by detecting light from the sample by a detector so as to produce differently focused images of the sample, and determining from the different images the quantitative phase data by an algorithm which solves the transport of intensity equation so as to produce a phase map of the sample in which the phase data is contained.

3. The method of claim 1 wherein the step of determining the boundary of the sample comprises forming a histogram of quantitative phase data measurements of the sample and background, taking the derivative of the histogram to thereby determine the point of maximum slope of the histogram in the vicinity of the boundary of the sample, and determining a line of best fit on the derivative to obtain a data value applicable to the boundary so that data values either above or below the determined data value are deemed within the sample.

4. The method of claim 3 wherein the step of determining the area or confluency comprises determining the area of confluency from the number of data samples which are within the boundary.

5. The method of claim 4 wherein each data sample is applicable to a pixel of a detector and the area of each pixel is known, so that from the known area of the pixels and the number of pixels which register a data value above or below the predetermined data value, the area or confluency of the sample is determined.

6. A method of determining the area or confluency of a sample comprising:
detecting light emanating from the sample by a detector to form at least two images of the sample which are differently focused to provide two sets of raw data;
from the two sets of raw data, determining a quantitative phase map of the sample and its background;
determining a boundary of the sample from individual phase data values applicable to pixels of the detector which are either above or below a determined pixel value; and
determining the area or confluency by multiplying the pixel area by the number of pixels which are either above or below the determined pixel value to thereby determine the area or confluency of the sample.

7. The method of claim 6 wherein the pixel values are grey scale values and grey scale values above a determined grey scale value are deemed to be within the sample and are multiplied by the pixel area to determine the area or confluency of the sample.

8. The method of claim 6 wherein the determined pixel value is determined by identifying the greatest rate of change of grey scale pixel values, thereby identifying the boundary of the sample.

9. The method of claim 8 wherein the greatest rate of change is determined by forming a histogram of grey scale values for all of the pixels which detect the sample and its background, determining the derivative of the histogram to provide a graphical measure of the greatest rate of change of grey scale values at various pixels, and determining the line of best fit of the curve to determine the grey scale value which defines the boundary of the sample so that all grey scale values which are greater than the determined grey scale value are deemed to be within the sample.

10. The method of claim 6 wherein the raw data comprises at least one in focus image of the sample and at least one out of focus image of the sample.

11. The method of claim 10 wherein the raw data comprises the in focus image of the sample and one positively defocused image and one negatively defocused image of the sample.

12. An apparatus for determining the area or confluency of a sample, comprising:
a processor for:
receiving quantitative phase data relating to the sample and background surrounding the sample;
determining from the quantitative phase data the boundary of the sample; and
determining the area within the boundary in order to determine either the area of the sample or the confluency of the sample.

13. The apparatus of claim 12 wherein the apparatus further comprises a detector for producing differently focused images of the sample, and the processor is for determining from the different images the quantitative phase data by an algorithm which solves the transport of intensity equation so as to produce a phase map of the sample in which the phase data is contained.

14. The apparatus of claim 13 wherein the processor determines the boundary of the sample by forming a histogram of quantitative phase data measurements of the sample and background, taking the derivative of the histogram to thereby determine the point of maximum slope of the histogram in the vicinity of the boundary of the sample, and determining a line of best fit on the derivative to obtain a data value applicable to the boundary so that data values either above or below the determined data value are deemed within the sample.

15. The apparatus of claim 13 wherein the processor determines the area or confluency by determining the area of confluency from the number of data samples which are within the boundary.

16. The apparatus of claim 15 wherein each data sample is applicable to a pixel of a detector and the area of each pixel is known, so that the processor, from the known area of the pixels and the number of pixels which register a data value above or below the predetermined data value, determines the area or confluency of the sample.

17. An apparatus for determining the area or confluency of a sample comprising:
a detector for detecting light emanating from the sample to form at least two images of the sample which are differently focused to provide two sets of raw data;
a processor for determining from the two sets of raw data, a quantitative phase map of the sample and its background;
the processor also determining a boundary of the sample from individual phase data values applicable to pixels of the detector which are either above or below a determined pixel value; and
the processor also determining the area or confluency by multiplying the pixel area by the number of pixels which are either above or below the determined pixel value to thereby determine the area or confluency of the sample.

18. The apparatus of claim 17 wherein the pixel values are grey scale values and grey scale values above a determined grey scale value are deemed to be within the sample and are multiplied by the pixel area to determine the area or confluency of the sample.

19. The apparatus of claim 18 wherein the determined pixel value is determined by identifying the greatest rate of change of grey scale pixel values, thereby identifying the boundary of the sample.

20. The apparatus of claim 19 wherein the greatest rate of change is determined by the processor forming a histogram of grey scale values for all of the pixels which detect the sample and its background, determining the derivative of the histogram to provide a graphical measure of the greatest rate of change of grey scale values at various pixels, and determining the line of best fit of the curve to determine the grey scale value which defines the boundary of the sample so that all grey scale values which are greater than the determined grey scale value are deemed to be within the sample.

21. The apparatus of claim 17 wherein the raw data comprises at least two defocused images equally spaced either side of the focus.

22. The apparatus of claim 21 wherein the raw data comprises the in focus image of the sample and one positively defocused image and one negatively defocused image of the sample.

23. A computer program for determining the area or confluency of a sample from providing quantitative phase data relating to the sample and background surrounding the sample, comprising:
code for determining from the quantitative phase data the boundary of the sample; and
code for determining the area within the boundary in order to determine either the area of the sample or the confluency of the sample.

24. The computer program of claim 23 wherein the quantitative phase data is obtained by detecting light from the sample by a detector so as to produce differently focused images of the sample, and the program includes code for determining from the different images the quantitative phase data by an algorithm which solves the transport of intensity equation so as to produce a phase map of the sample in which the phase data is contained.

25. The computer program of claim 23 wherein the code for determining the boundary of the sample comprises code for forming a histogram of quantitative phase data measurements of the sample and background, code for taking the derivative of the histogram to thereby determine the point of maximum slope of the histogram in the vicinity of the boundary of the sample, and code for determining a line of best fit on the derivative to obtain a data value applicable to the boundary so that data values either above or below the determined data value are deemed within the sample.

26. The computer program of claim 23 wherein the code for determining the area or confluency comprises code for determining the area of confluency from the number of data samples which are within the boundary.

27. The computer program of claim 26 wherein each data sample is applicable to a pixel of a detector and the area of each pixel is known, so that from the known area of the pixels and the number of pixels which register a data value above or below the predetermined data value, the area or confluency of the sample is determined.

28. A computer program for determining the area or confluency of a sample by detecting light emanating from the sample by a detector to form at least two images of the sample which are differently focused to provide two sets of raw data, comprising:
code for determining from the two sets of raw data, a quantitative phase map of the sample and its background;
code for determining a boundary of the sample from individual phase data values applicable to pixels of the detector which are either above or below a determined pixel value; and
code for determining the area or confluency by multiplying the pixel area by the number of pixels which are either above or below the determined pixel value to thereby determine the area or confluency of the sample.

29. The computer program of claim 28 wherein the pixel values are grey scale values and grey scale values above a determined grey scale value are deemed to be within the sample and are multiplied by the pixel area to determine the area or confluency of the sample.

30. The computer program of claim 28 wherein the determined pixel value is determined by code for identifying the greatest rate of change of grey scale pixel values, thereby identifying the boundary of the sample.

31. The computer program of claim 30 wherein the greatest rate of change is determined by code for forming a histogram of grey scale values for all of the pixels which detect the sample and its background, code for determining the derivative of the histogram to provide a graphical measure of the greatest rate of change of grey scale values at various pixels, and code for determining the line of best fit of the curve to determine the grey scale value which defines the boundary of the sample so that all grey scale values which are greater than the determined grey scale value are deemed to be within the sample.

32. The computer program of claim 28 wherein the raw data comprises at least one in focus image of the sample and at least one out of focus image of the sample.

33. The computer program of claim 32 wherein the raw data comprises the in focus image of the sample and one positively defocused image and one negatively defocused image of the sample.
